(19) United States
(12) Patent Application Publication
(10) Pub. No.: US 2004/0264563 A1
(43) Pub. Date: Dec. 30, 2004

(54) Terminal used in video transmission system

(76) Inventors: Akino Inoue, Tokyo (JP); Sachiko Takeshita, Tokyo (JP); Masaki Sato, Chiba (JP); Toshio Oka, Kanagawa (JP); Daisaku Komiya, Kanagawa (JP); Satoshi Senga, Saitama (JP)

Correspondence Address: PEARNE & GORDON LLP, 1801 EAST 9TH STREET, SUITE 1200, CLEVELAND, OH, 44114-3108, US

(21) Appl. No.: 10/494,430

(22) PCT Filed: Oct. 31, 2002
(86) PCT No.: PCT/JP02/11396

(30) Foreign Application Priority Data
Nov. 5, 2001 (JP) 2001-339540

(51) Int. Cl. H04N 7/12

(52) U.S. Cl. 375/240.01

(57) ABSTRACT

Provided is a terminal unit that, even in case video image is suspended by a handover, video reproduction is possible real-time at immediately after an end of the handover. In a video transmission system comprising a wireless LAN accommodated switch for switching over the connection relationship of a terminal unit and an access point, an access point for receiving video data sent from a terminal unit and sending it to another terminal unit, and a terminal unit for receiving video data sent from the access point thereby displaying a video image and carrying out an association establishment or release of a wireless channel to an access point, the terminal unit operates such that, when a calling party releases a wireless channel, the opposite terminal unit determines that the calling party has started a handover and makes an operation to change a video data encoding into an intra-frame encoding.

### TECHNICAL FIELD

The present invention relates to a terminal unit for utilization in a video transmission system on a wireless network, and more particularly to a terminal unit for utilization in realizing a video transmission system that, even in the event of a suspension of video image due to a handover, the video image is to be played real-time at immediately after ending of the handover.

### BACKGROUND ART

The video data, to be sent in a video transmission system, is usually compression-encoded under the H.261 scheme, the MPEG scheme or the like. These compression encode schemes selectively use, by change over, an intra-frame encoded image that the pixel value is encoded as it is, and a inter-frame predictive encoded image that the difference from a reference frame is encoded. The image less in movement or change, because of extreme similarity between the current frame and the preceding frame, uses a inter-frame predictive encoded image that encoding is on the difference of from the preceding frame. On the other hand, the video image greater in movement or change or the video image of upon a scene change is smaller in the correlation between the frames, hence using an intra-frame encoded image that encoding is directly on the pixel value. Accordingly, in a video transmission system to transmit a video image less in scene change and not much in subject movement as in television conference, an intra-frame encoded image is first transmitted, and from then on, a inter-frame predictive encoded image is sent out.

In the below, explanation is made on the case using a terminal unit capable of sending and receiving video and audio data through an access point, in the conventional video transmission system using a wireless network. FIG. 8 is an explanatory figure explaining the arrangement and operation of the conventional video transmission system.

As shown in FIG. 8, the terminal unit 901 capable of sending and receiving video data (hereinafter, collectively referred to as “data”) is a terminal capable of sending and receiving video data through an access point (AP1) or an access pint 2 (AP2). The access point, where the relevant terminal unit 901 is to utilize, is switched over by the wireless LAN switch 903. FIG. 9 shows an internal configuration of the terminal unit 901 to be used in the conventional video transmission system. As shown in the figure, the terminal unit 901 is configured having a video input section 951, a video encoding section 953, a video transmitting section 955, an audio input section 957, an audio encoding section 956, an audio transmitting section 961, a video receiving section 963, a video decoding section 965, a video display section 967, an audio receiving section 969, an audio decoding section 971 and an audio output section 973.

Next, explanation is made on the operation that the access point through which the data from the terminal unit 901 or the data to the terminal unit 901 passes is shifted from AP1 to AP2 by a movement of the above-explained terminal unit 901. At first, (1) in the state that an association is established of the terminal unit 901 with the AP1, (2) the terminal unit 901 releases the association established. Because an ID of the AP2 has been sent from the AP2 to the terminal unit 901 established an association with the AP1, the terminal unit 901 releases the association established with the AP1 and then (3) requests the AP2 to establish an association. (4) When the AP2 sends a response of establishment OK back to the terminal unit 901 in response to this request, (5) the terminal unit 901 establishes an association with the AP2.

### DISCLOSURE OF THE INVENTION

However, when the access point is changed over (handover) in the conventional video transmission system, the terminal unit 901 is not supplied with data in a duration of from the “(2) release” up to “(5) establishing an association with a new access point”, i.e. resulting in an occurrence of packet loss. Moreover, as shown in FIG. 10 for example, in case the video data of upon establishing an association with a new access point is of a inter-frame forward predictive encoded image (P picture), the P picture (P3-P4) is data having a nature that encoding is on the difference of from the preceding frame. Accordingly, the terminal unit 901, despite performing the usual data transmission due to an end of handover, cannot play a normal video image before transmission of an intra-frame encoded image (I picture) even if the handover is over.

The video transmission system for utilization in television conference, etc. is generally designed on the policy that priority is placed on data transmission without causing delay rather than on reliability. However, in the conventional video transmission system, there is a possibility to cause a time that normal video images are not played despite the handover is ended into an association established with the access point. There has been a problem of unnecessarily long video suspension time due to a handover. Therefore, there is a desire for a video transmission system that, even in case video image is suspended by a handover, play of video images is possible without delay at immediately after ending the handover. Incidentally, the “video image” in the above explanation does not include a visually broken image but refers to only a normal image.

The present invention has been made in view of the above problem in the conventional, and it is an object to provide a terminal unit for realizing a video transmission system that, even in case video image is suspended by a handover, normal video images can be played real-time at immediately after an end of handover.

Therefore, a terminal unit according to the present invention is a terminal unit for sending/receiving video data to/from another terminal unit through an access point an association is established, the terminal unit comprising: a video data reception status monitoring section for monitoring, packet by packet, a reception status of video data sent from an access point an association is established; an association establishment status detecting section for detecting a release or association establishment of a wireless channel by the other terminal unit based on the reception status of video data monitored by the video data reception status monitoring section; and a video data encoding section for encoding video data to be sent to the other terminal unit, under any of an intra-frame encoding or a inter-frame encoding; whereby the association establishment status detecting section, before the wireless channel is released, instructs the video data encoding section to change the post-release video data encoding for sending to the other terminal unit into an intra-frame encoding, and the other terminal unit to encode the post-release video data under the intra-frame encoding.

Meanwhile, in the terminal unit of the invention, the association establishment status detecting section instructs the video data encoding section to change the video data encoding for sending to the other terminal unit into a inter-frame encoding and the other terminal unit to encode the post-association-establishment video data under the inter-frame encoding, if an association is established with another access point after releasing of the wireless channel.

Meanwhile, a terminal unit according to the present invention is a terminal unit for sending/receiving video data to/from another terminal unit through an access point an association is established, the terminal unit comprising: a wireless channel releasing section for releasing a wireless channel with an access point an association is established; a release notifying section for notifying the other terminal unit of a release of a wireless channel; a wireless channel association establishing section for establishing a new association of a wireless channel with another access point; an association establishment notifying section for notifying the other terminal unit of an association established with another access point; and a notification receiving section for receiving a notification from a release notifying section or association establishing section possessed by the other terminal unit; whereby the notification receiving section instructs the video data encoding section to encode video data under an intra-frame encoding when receiving a notification showing a release of a wireless channel.

Meanwhile, in the terminal unit of the invention, the notification receiving section further instructs the video data encoding section to encode video data under a inter-frame encoding when receiving a notification showing a association established.

Meanwhile, the terminal unit of the invention further comprises an encode mode change notifying section for notifying another terminal unit of a fact the video data encoding has been changed into an intra-frame encoding or a inter-frame encoding according to an instruction from the notification receiving section, wherein, when the reception notifying section receives a notification from the encode mode change notifying section the other terminal unit possesses, the video data encoding section changes the video data encoding for sending to the other terminal unit into a post-change encoding in the other terminal unit.

### BRIEF DESCRIPTION OF THE DRAWINGS

FIG. 1 is an explanatory figure showing the arrangement and operation of a video transmission system according to a first embodiment of the invention.

FIG. 2 is a block diagram showing an internal configuration of a terminal unit to be used in the video transmission system of the first embodiment.

FIG. 3 is an explanatory figure explaining the packet when a handover is made in the first and second embodiment

FIG. 4 is a block diagram of another example showing an internal configuration of a terminal unit to be used in the video transmission system of the first embodiment.

FIG. 5 is an explanatory figure showing the arrangement and operation of a video transmission system according to a second embodiment of the invention.

FIG. 6 is a block diagram showing an internal configuration of a terminal unit to be used in the video transmission system of the second embodiment.

FIG. 7 is a block diagram showing an internal configuration of a terminal unit to be used in the video transmission system of a third embodiment.

FIG. 8 is an arrangement figure showing a video transmission system in the prior art.

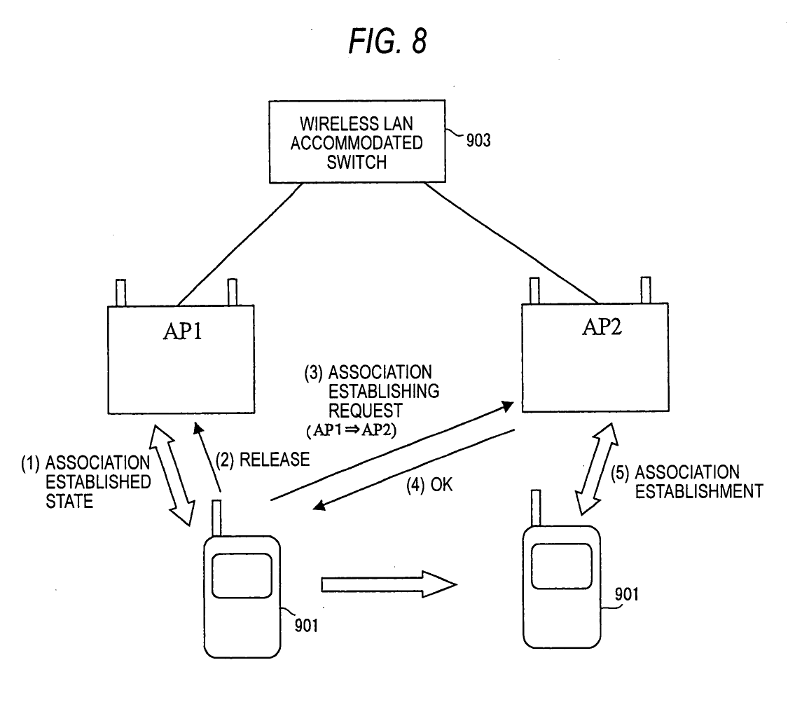

FIG. 9 is a block diagram showing an internal configuration of a terminal unit to be used in the video transmission system in the prior art.

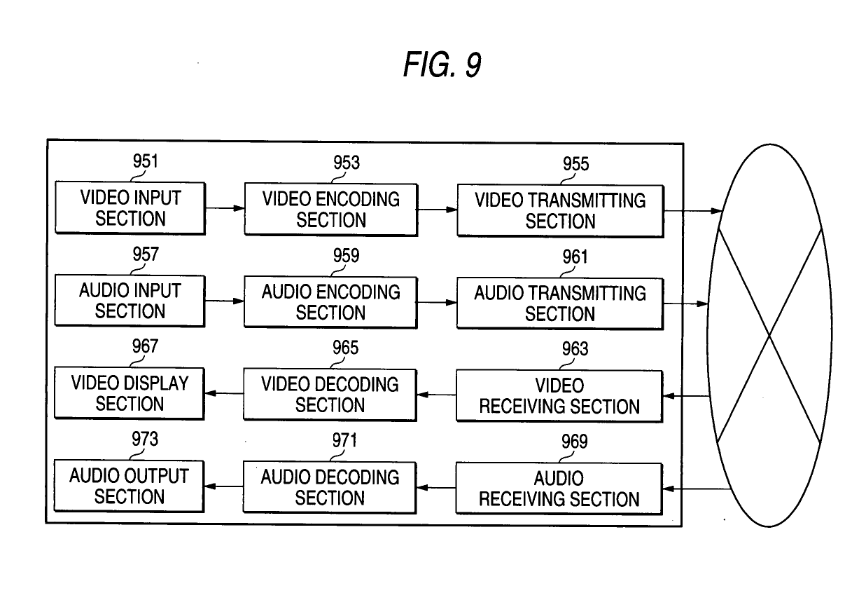

FIG. 10 is an explanatory figure showing a video play suspended section upon an occurrence of packet loss due to a handover.

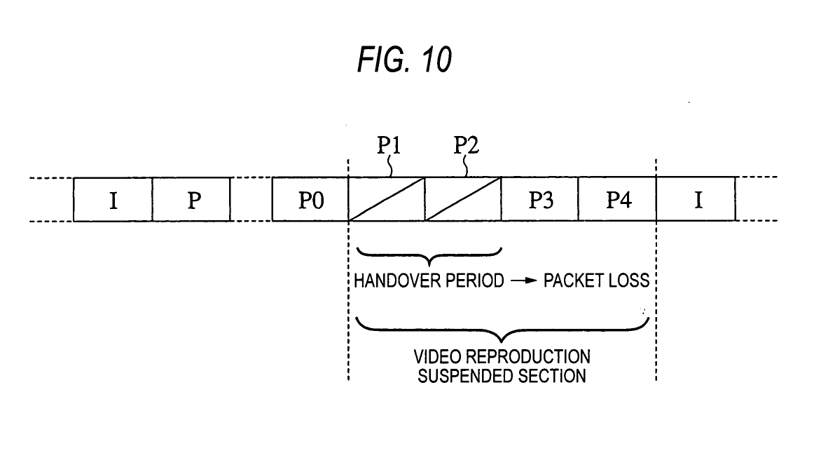

Meanwhile, in the above drawings, the reference number 101, 501, 701 represents a terminal unit; 101a, 501a calling party; 101b, 501b an opposite terminal unit; AP1-AP3, AP an access point; 103 a wireless LAN accommodated switch; 151 a video data receiving section; 153 a video data selective discarding section; 155 a video data decoding section; 157 a video display section; 159 an audio data receiving section; 161 an audio data selective discarding section; 163 an audio data decoding section; 165 an audio output section; 171 a video data input section; 173 a video data encoding section; 175 a video data transmitting section; 177 an audio data input section; 179 an audio data encoding section; 181 an audio data transmitting section; 201 a packet reception status monitoring section; 203 a handover start/end detecting section; 401 a network error rate measuring section; 601 a wireless channel releasing section; 603 a wireless channel association establishing section; 605 a handover notifying section; 607 a handover restoration notifying; 609 a handover notification receiving section; 751 a participation on the way notification transmitting section; 753 a participation on the way notification receiving section, respectively.

### BEST MODE FOR CARRYING OUT THE INVENTION

The terminal unit of the present invention is for utilization in a video transmission system for sending video data to a terminal unit through the utilization of a wireless network, wherein video data is to be sent, packet by packet, through access points. Incidentally, “I picture” to appear in the below explanation means an intra-frame coded image to be generated upon compression encoding while “F picture” represents a inter-frame forward predictive coded image.

Hereunder, explanation is made in detail on embodiments of a video transmission system and video suspension restoring method according to the present invention, with reference to the drawings in the order of [first embodiment], [second embodiment] and [third embodiment].

### FIRST EMBODIMENT

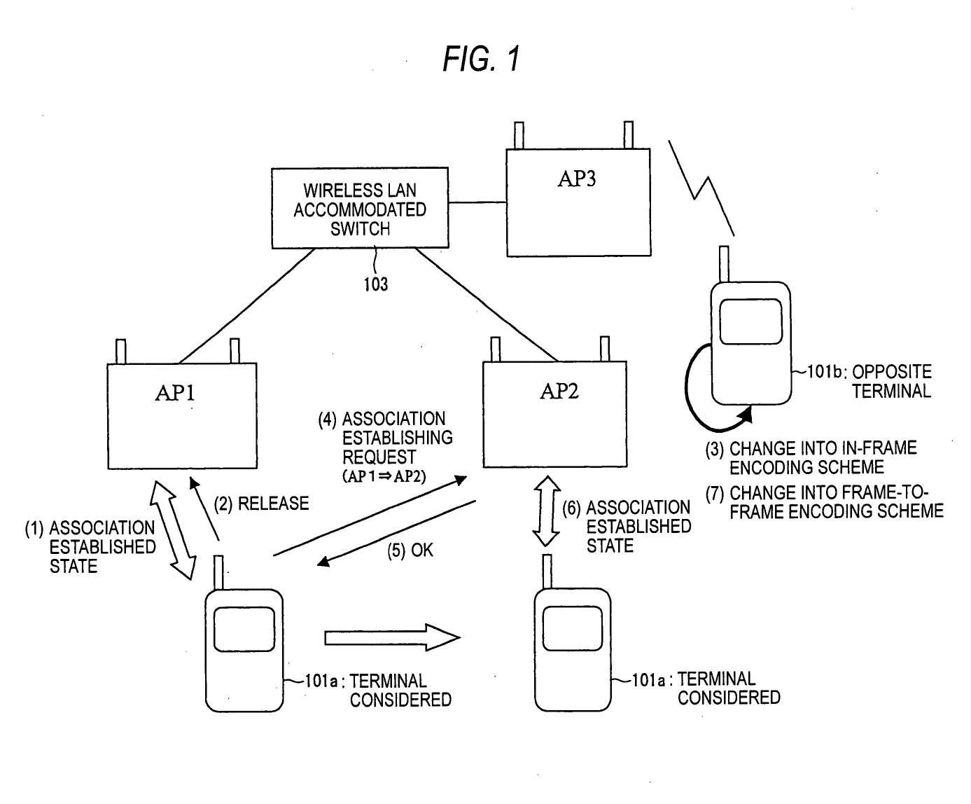

FIG. 1 is an explanatory figure showing the arrangement and operation of a video transmission system, according to a first embodiment of the present invention. In the figure, the video transmission system of the first embodiment is arranged with a wireless LAN switch 103, access points AP1-AP3, a calling party 101a, and a called party 101b. Incidentally, in the ensuing explanation, the access points AP1, AP2 collectively are to be referred to as an access point AP while the calling party 101a considered and the called party 101b collectively are to be referred to as a terminal unit 101.

Hereunder, explained are the constituent elements the video transmission system of this embodiment possesses.

At first, the wireless LAN switch 103 is to switch over the connection relationship between the terminal unit 101 and the access point AP. Meanwhile, the access point AP is to receive the video data sent from the terminal unit 101 and send it to another terminal unit. Meanwhile, the terminal unit 101 is to receive the video data sent from the access point AP and display a video image, which also is to establish an association of and release a wireless channel with the access point AP.

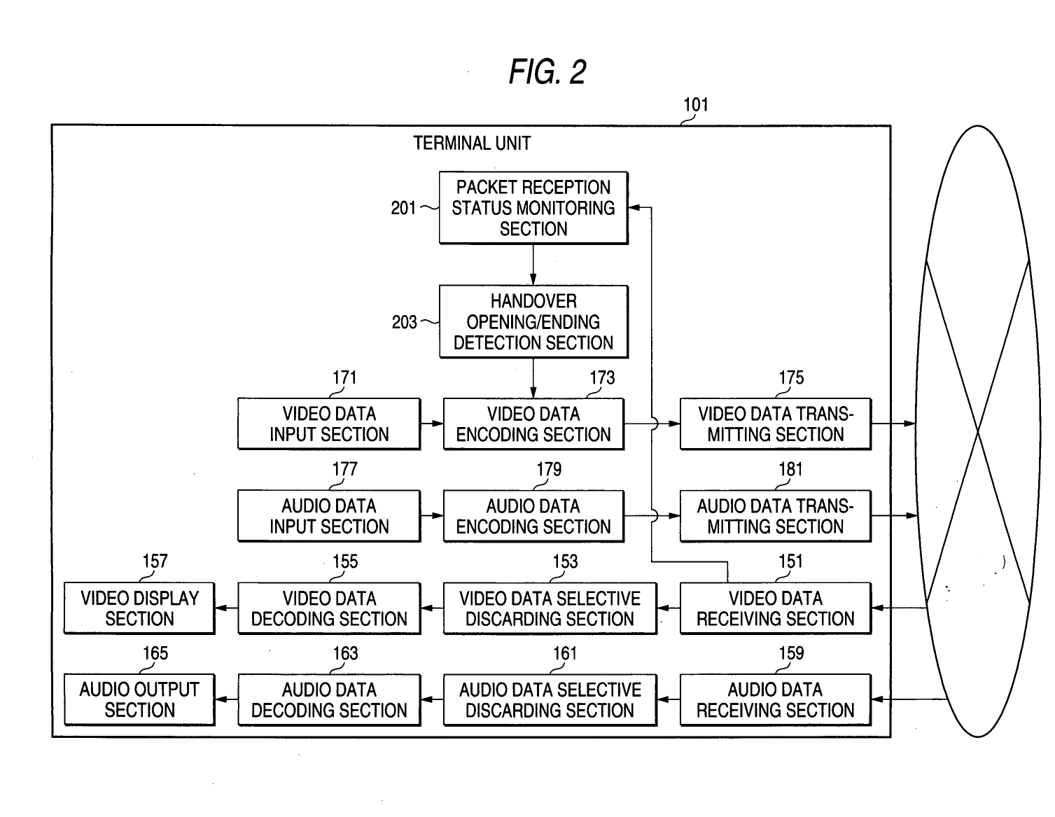

FIG. 2 shows an internal configuration of the terminal unit used in the video transmission system of the first embodiment. As shown in the figure, the terminal unit 101 is configured having a packet-reception-status monitoring section 201 corresponding to a video-data-reception-state monitoring state in the claim and a handover start/end detecting section 203 corresponding to an association-establishing-status detecting section, in addition to a video data receiving section 151, a video data selective discarding section 153, a video data decoding section 155, a video display section 157, an audio data receiving section 159, an audio data selective discarding section 161, an audio decoding section 163, an audio output section 165, a video data input section 203, a video data encoding section 173, a video data transmitting section 175, an audio data input section 177, an audio data encoding section 179, and an audio data transmitting section 181.

In the terminal unit 101, the video data sent from the access point AP is received at the video data receiving section 151, and then a part of the video data is selectively discarded in the video data selective discarding section 153. The video data not discarded in the video data selective discarding section 153 is decoded in the video data decoding section 155 and displayed on the video display section 157. Similarly, audio data also is received at the audio data receiving section 159, and then a part of the audio data is selectively discarded in the audio data selective discarding section 161. The audio data not discarded in the audio data selective discarding section 161 is decoded in the audio data decoding section 163, and outputted from the audio output section 165.

Meanwhile, when sending video data or audio data from the terminal unit 101, the video data inputted to the video data input section 171 is compression-encoded in the video data encoding section 173, and then the encoded video data is sent from the video data transmitting section 175. Similarly, the audio data inputted to the audio data input section 177 is compression-encoded in the audio data encoding section 179, and then the encoded audio data is sent from the audio data transmitting section 181.

The packet-reception-status monitoring section 201 possessed by the terminal unit 101 monitors, packet by packet, the video data received at the video data receiving section 151, thereby monitoring as to whether video data is being sent onto the terminal unit 101. Meanwhile, the handover start/end detecting section 203 detects a start or end of handover (switching over the access point AP by the terminal unit 101) by the terminal unit 101, on the basis of a packet reception status being monitored by the packet-reception-state monitoring section 201. At a start of handover, it instructs the video data encoding section 173 to encode the video data under the intra-frame encoding. At an end of handover, it instructs the video data encoding section 173 to encode the video data under the inter-frame encoding. Due to this, according to the instruction from the handover start/end detecting section 203, the terminal unit 101 can make as “intra-frame encoded image (I picture)” the data to send during a handover carried out by the called party.

Next, in the video transmission system having the above explained constituent elements, explanation is made on the operation to shift the access point establishing an association from AP1 to AP2 due to a movement of the calling party 101a, as a video-suspension restoring method in a first embodiment, with reference to FIG. 1.

At first, (1) in a state the calling party 101a is established an association with the access point AP1 and the called party 101b is established an association with the access point AP3 in which state video-data transmission and reception is being made between the calling party 101a and the called party 101b, (2) the calling party 101a releases the wireless channel on which an association is established. Because the called party 101b at its packet-reception-status monitoring section 201 is monitoring the packet reception status of video data from the calling party 101a, when the calling party 101a releases the wireless channel, the called party 101b determines that the calling party 101a starts a handover and (3) changes the video-data encoding into the intra-frame encoding.

Meanwhile, the calling party 101a, when established an association with the AP1, has been sent with an ID of the AP2 from the access point AP2. Accordingly, after the association establishment with the AP1 is released, (4) it requests the AP2 to establish an association of wireless channel. (5) When the AP2 sends a response of establishment OK back to the calling party 101a in response to the request, (6) the calling party 101a establishes an association of wireless channel with the AP2. As described above, the called party 101b at its packet-reception-status monitoring section 201 is monitoring the packet reception status of video data from the calling party 101a. Accordingly, when the calling party 101a establishes an association with the AP2, the called party 101b determines that the calling party 101a has ended the handover and (7) changes the video-data encoding from the intra-frame encoding into the inter-frame encoding.

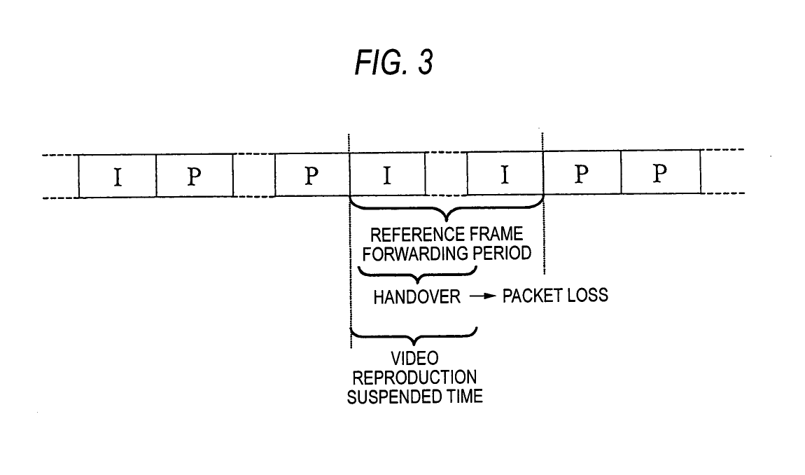

As explained above, in the video transmission system and video-suspension restoring method of this embodiment, the compression encoding to be made in the video data encoding section 173 of the called party 10b is changed in scheme in timing with a start of handover on the calling party 101a. More specifically, when a handover is started on the calling party 101a, the called party 101b compression-encodes video data under the intra-frame encoding. Accordingly, as shown in FIG. 3, during a handover of the calling party 101a, an intra-frame encoded image (I picture) is sent from the called party 101b.

Accordingly, because the video data the calling party 101a is to receive immediately after ending the handover is an intra-frame encoded image (I picture) the pixel value has been encoded as it is, the calling party 101a can play normal image real-time at immediately after ending of the handover. Incidentally, when the handover is ended, the called party 101b compression-encodes the video data under the inter-frame encoding. Accordingly, the calling party 101a after receiving an I picture is to receive a P picture.

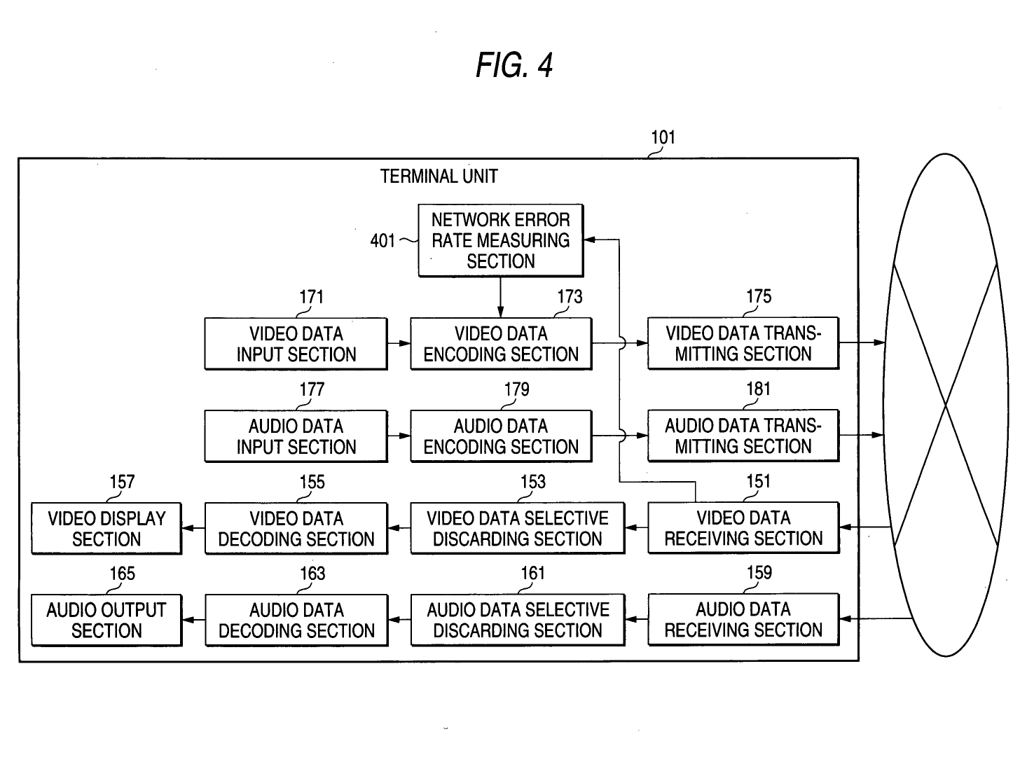

Incidentally, the terminal unit T, as shown in FIG. 4, may be provided with a network error rate measuring section 401 for measuring a network error rate from the reception status of a sequence number contained in the video data in the video data receiving section 151, in place of the packet-reception-status monitoring section 201 and handover start/end detecting section 203. At this time, the terminal unit 101 changes the scheme of the compression encoding to be made in the video data encoding section 173, according a comparison result of an error rate measured at the network error rate measuring section with a predetermined threshold. More specifically, when the error rate is less than a threshold, the encoding is madeas the intra-frame encoding. When it is equal to or greater than the threshold, the intra-frame encoding is applied.

### SECOND EMBODIMENT

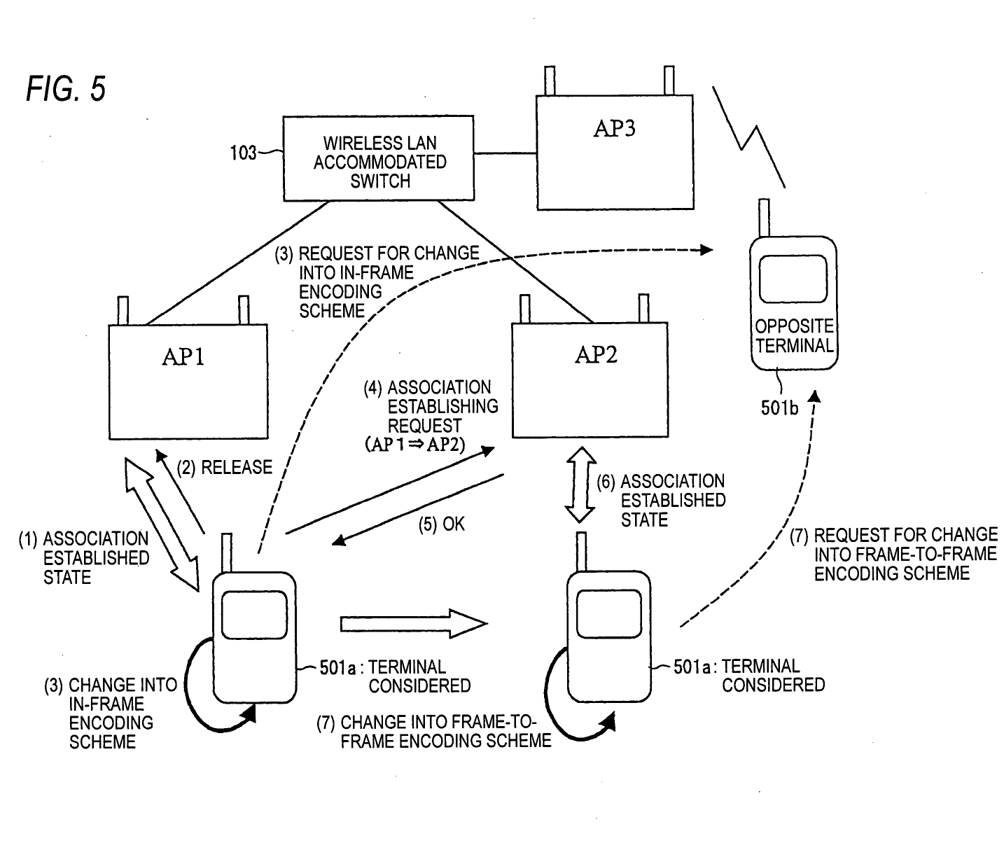

FIG. 5 is an explanatory figure showing the arrangement and operation of a video transmission system according to a second embodiment of the present invention In the figure, because the arrangement of the video transmission system of the second embodiment is generally similar to that of the first embodiment, the parts duplicated by FIG. 1 (first embodiment) are attached with the same references thereby omitting of explanation.

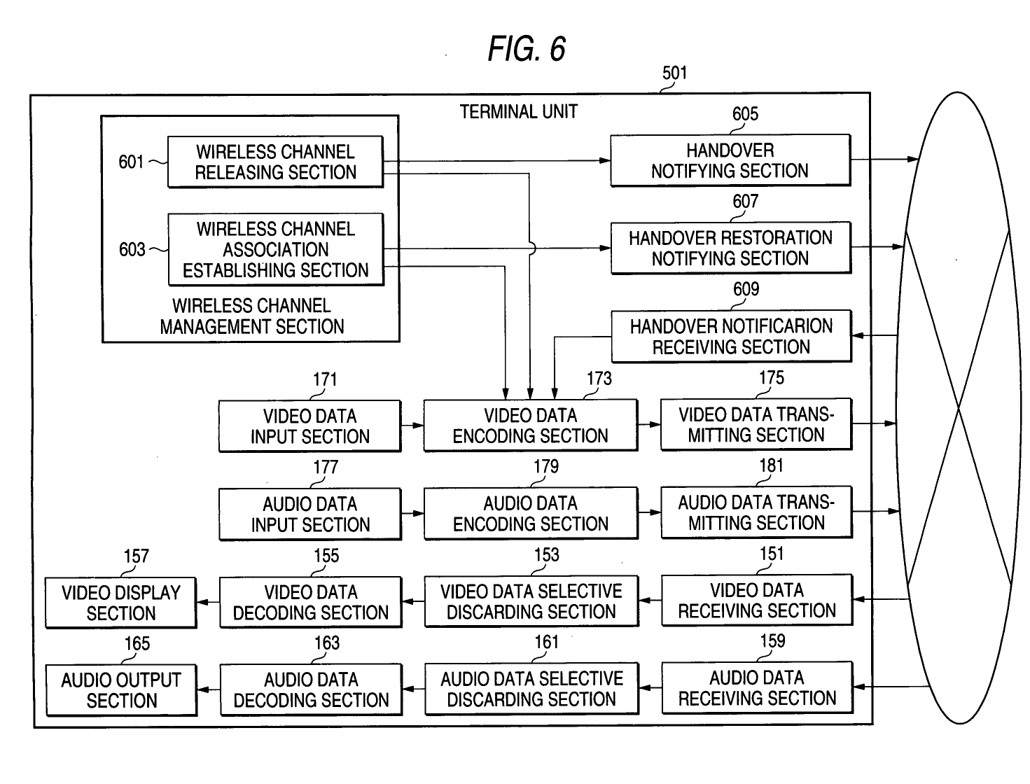

However, instead of having a packet-reception-status monitoring section 201 and handover start/end detecting section 203 as in the first embodiment, the terminal unit 501 of this embodiment has a wireless channel releasing section 601, a wireless channel association establishing section 603, a handover notifying section 605 corresponding to a release notifying section in the claim, a handover restoration notifying section 607 corresponding to an association establishment notifying section, and a handover notification receiving section 609 corresponding to a notification receiving section. FIG. 6 shows an internal configuration of the terminal unit 501 used in the video transmission system of the second embodiment. Incidentally, the wireless channel releasing section 601 and the wireless channel association establishing section 603 collectively are referred to as a “wireless channel managing section”.

The wireless channel releasing section 601 is to release the wireless channel with an access point on which an association is established. When the wireless channel is released, it instructs the video data encoding section 173 to change the video-data encoding into the intra-frame encoding. Meanwhile, the wireless channel association establishing section 603 is to establish an association of wireless channel with a new access point. When an association is established, it instructs the video-data encoding section 173 to change the video-data encoding into the inter-frame encoding.

Meanwhile, the handover notifying section 605 is to notify another terminal unit under video-data communication of a fact of handover start when instructed to release the wireless channel by the wireless channel releasing section 601. Meanwhile, the handover restoration notifying section 607 is to notify another terminal unit under video-data communication of a fact the handover is ended into restoration when instructed to establish an association of wireless channel by the wireless channel association establishing section 603.

Meanwhile, the handover notification receiving section 609 is to receive a handover notification or handover restoration notification sent from another terminal unit. The handover notification receiving section 609, when received a handover notification, instructs the video-data encoding section 173 to change the video-data encoding into the intra-frame encoding On the other hand, when received a handover restoration notification, it instructs the video-data encoding section 173 to change the video-data encoding into the inter-frame encoding.

Next, in the video transmission system having the above explained constituent elements, explanation is made on the operation to shift the access point establishing an association AP1 to AP2 by a movement of the calling party 501a, as a video-suspension restoring method in the second embodiment, with reference to FIG. 5.

At first, (1) in a state the calling party 501a is established an association with the access point AP1 and the called party 501b is established an association with the access point AP3 in which state video-data exchange is being made between the calling party 101a and the called party 101b, (2) the calling party 501a releases the wireless channel on which an association is established. Immediately before releasing the wireless channel, (3) the calling party 501a changes the video-data encoding into the intra-frame encoding, and requests the called party 501b to change the video-data encoding into the intra-frame encoding.

Meanwhile, the calling party 501a when established an association with the AP1 has been sent with an ID of the AP2 from the access point AP2. Accordingly, after the association establishment with the AP1 is released, (4) it requests the AP2 to establish an association of wireless channel. (5) When the A2 sends a response of establishment OK back to the calling party 501a in response to the request, (6) the calling party 501a establishes an association of wireless channel with the AP2. When an association is established, (7) the calling party 501a changes the video-data encoding into the inter-frame encoding, and requests the called party 501b to change the video-data encoding into the inter-frame encoding.

As explained above, in the video transmission system and video-suspension restoring method of this embodiment, when the calling party 501a starts a handover, the called party 501b changes the video-data compression-encoding to be made in the video-data encoding section 173. More specifically, when the called party 501b is notified of a fact that the calling party 501a has started a handover, the called party 501b makes a compression encoding of the video data under the intra-frame encoding. Accordingly, as shown in FIG. 3, during a handover of the calling party 501b, an intra-frame coded image (I picture) is sent from the called party 501b.

Consequently, because the video data the calling party 501a is to receive immediately after ending the handover is an intra-frame encoded image (I picture) the pixel value has been encoded as it is, the calling party 501a can play normal image real-time at immediately after ending of the handover. Incidentally, in case the handover is ended and the called party 501b is notified of a fact the terminal unit concerned 501b has ended the handover, the called party 501b makes a compression encoding of the video data under the inter-frame encoding. Accordingly, the calling party 101a after receiving an I picture is to receive a P picture.

### THIRD EMBODIMENT

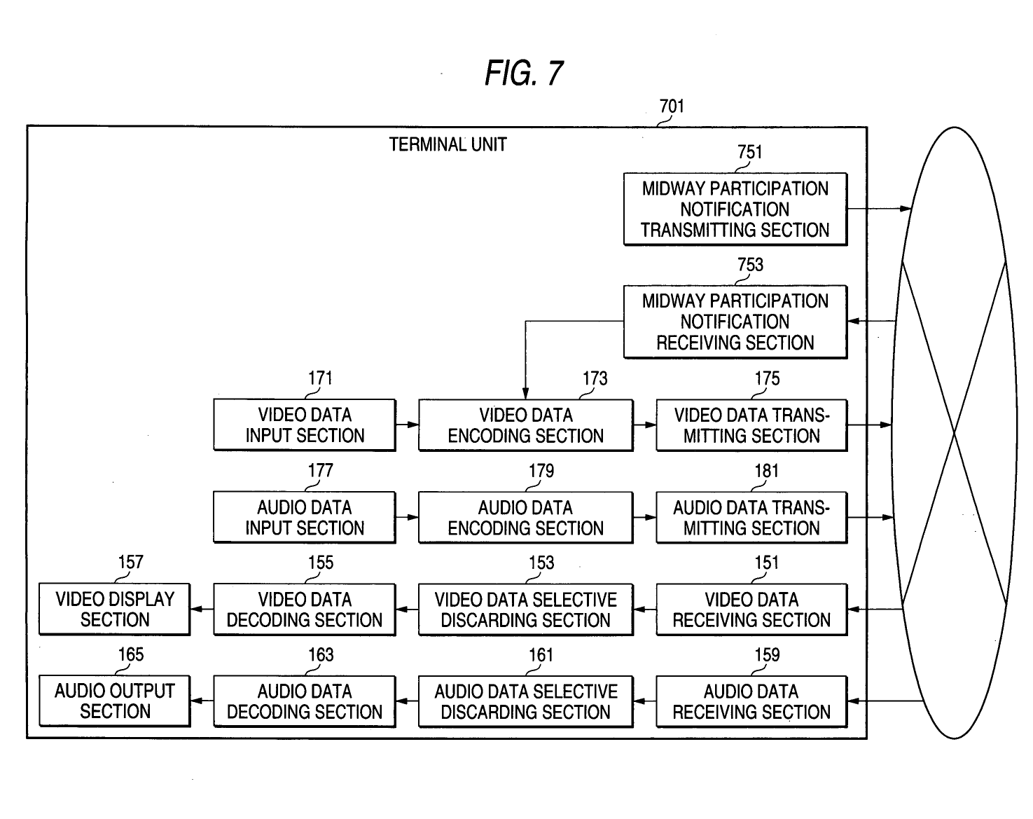

Because the arrangement of the video transmission system of the second embodiment is generally similar to that of the first embodiment, the parts duplicated by FIG. 1 (first embodiment) are attached with the same references thereby omitting of explanation. FIG. 7 shows an internal configuration of a terminal unit to be used in the video transmission system of the third embodiment. As shown in the figure, a terminal unit 701 of the third embodiment is configured having a participation on the waynotification transmitting section 751 corresponding to a new association establishment notifying section in the claim and a participation on the way notification receiving section 753 corresponding to a new association establishment notification receiving section, in addition to a video data receiving section 151, video data selective discarding section 153, a video data decoding section 155, a video display section 157, an audio data receiving section 159, an audio data selective discarding section 161, an audio decoding section 171, an audio output section 165, a video data input section 203, a video data encoding section 173, a video data transmitting section 175, an audio data input section 177, an audio data encoding section 179, and an audio data transmitting section 181.

The participation on the way notification transmitting section 751 is to notify another terminal unit of participation in the course when the present terminal unit 701 takes part in a television conference or the like. Meanwhile, the participation notification on the way receiving section 753 is to receive a notification of participation sent from another terminal unit in the course of holding a television conference or the like. When receiving the relevant notification, it instructs the video-data encoding section 173 to carry out the video-data compression encoding for a predetermined time under the intra-frame encoding.

Incidentally, the notification of midway participation may be forwarded to all the terminal units under television conference or the like (multicast) or to one terminal unit (unicast). Nevertheless, in the case of sending to one terminal unit, the relevant terminal unit transfers it to the other terminal units such that all the terminal units receive the notification of participation.

Next, explanation is made concerning a predetermined time that the video data encoding section 173 makes a compression encoding under the intra-frame encoding when the midway participation notification receiving section 753 receives a notification of midway participation. First of all, for the relevant predetermined time, the time required for forwarding frames for a predetermined time or in a predetermined number is given as the predetermined time.

Meanwhile, secondly, in case the terminal unit sends a participation on the way notification to another terminal unit with a result that the terminal unit receives an intra-frame encoded image (I picture), the terminal unit notifies another terminal unit of a fact the terminal unit has received the relevant I picture, in which contrivance the duration of from a reception of a participation on the way notification up to a notification of I picture reception is given as the predetermined time. Accordingly, in case the other terminal unit receives the notification of I picture reception, the encoding is changed to the inter-frame encoding Incidentally, concerning the notification of I picture reception, there is a difference in the number of transmission destination between multicast and unicast, similarly to participation on the way notification.

Meanwhile, thirdly, by providing the terminal unit 701 with the network error rate measuring section 401 shown in FIG. 4 of the first embodiment, the predetermined time is changed in accordance with the error rate measured by the network error rate measuring section 401. For example, assuming that two frames of reference image have been sent during midway participation in a state there is an error of one packet out of 100 packets, when the error rate changes to the twice (error of two packets out of 100 packets), four frames of I picture are sent during the participation. Incidentally, because a plurality of terminal units 701 exchange video data in the video transmission system, it is desired to make a matching to the highest terminal unit in error rate.

As explained above, even in case there is a terminal unit to participate midway in the video transmission system, the relevant terminal unit can display a video image in a brief time.

Although the present invention was explained in detail and with reference to the particular embodiments, it is apparent for the ordinary skilled person that various changes and modifications are possible without departing from the spirit and scope of the invention.

This application is based on Japanese Patent Application (Patent Application 2001-339475) filed on Nov. 5, 2001, the content of which is hereby incorporated by reference.

Industrial Applicability

As explained above, according to the video transmission system including a terminal unit of the present invention, the terminal unit even in the event of a suspension of video image due to a handover is allowed to reproduce a normal video image, without delay, at immediately after ending of the handover.

1. A terminal unit for sending/receiving video data to/from another terminal unit through an access point an association is established, the terminal unit comprising:
a video data reception status monitoring section for monitoring, packet by packet, a reception status of video data sent from an access point an association is established;
an association establishment status detecting section for detecting a release or association establishment of a wireless channel by the other terminal unit; and
a video data encoding section for encoding video data to be sent to the other terminal unit, under any of an intra-frame encoding or a inter-frame encoding;
whereby the association establishment status detecting section, before the wireless channel is released, instructs the video data encoding section to change the post-release video data encoding for sending to the other terminal unit into an intra-frame encoding, and the other terminal unit to encode the post-release video data under the intra-frame encoding.

2. A terminal unit according to claim 1, wherein the association establishment status detecting section
instructs the video data encoding section to change the video data encoding for sending to the other terminal unit into a inter-frame encoding and the other terminal unit to encode the post-association-establishment video data under the inter-frame encoding, if an association is established with another access point after releasing of the wireless channel.

3. A terminal unit for sending/receiving video data to/from another terminal unit through an access point an association is established, the terminal unit comprising:
a wireless channel releasing section for releasing a wireless channel with an access point an association is established;
a release notifying section for notifying the other terminal unit of a release of a wireless channel;
a wireless channel association establishing section for establishing a new association of a wireless channel with another access point;
an association establishment notifying section for notifying the other terminal unit of an association established with another access point; and
a notification receiving section for receiving a notification from a release notifying section or an association establishing section possessed by the other terminal unit;
whereby the notification receiving section instructs the video data encoding section to encode video data under an intra-frame encoding, when receiving a notification showing a release of a wireless channel.

4. A terminal unit according to claim 3, wherein the notification receiving section further
instructs the video data encoding section to encode video data under a inter-frame encoding, when receiving a notification showing a association established.
